(19) United States
(12) Patent Application Publication
(10) Pub. No.: US 2023/0350938 A1
(43) Pub. Date: Nov. 2, 2023

(54) GAYLE MAIL

(71) Applicant: MICHAEL SIMEON GAYLE

(72) Inventor: MICHAEL SIMEON GAYLE

(21) Appl. No.: 18/346,440

(22) Filed: Jul. 3, 2023

(51) Int. Cl. G06F 16/435

(52) U.S. Cl. CPC G06F 16/437

(57) ABSTRACT

The present invention provides a novel app called “Gayle Mail” that aggregates email inboxes and filters them using tags for items, subjects, and senders to ensure important emails are never missed. The app allows users to prioritize their email accounts, avoiding inbox clutter. Users can manually enter pre-filters or utilize the app's artificial intelligence capabilities to automatically configure settings based on user preferences and historical usage patterns.

### BACKGROUND OF THE INVENTION

In today's fast-paced digital era, individuals receive numerous emails daily, leading to information overload and the potential for important messages to be overlooked. Existing email filtering systems lack the ability to adapt to individual preferences and accurately prioritize emails. Therefore, there is a need for an intelligent app that can effectively filter and manage email inboxes to ensure important messages are promptly attended to.

### BRIEF SUMMARY OF THE INVENTION

The Gayle Mail app aims to address the above-mentioned problem by aggregating multiple email inboxes and employing advanced filtering techniques. The app offers the following functionalities:

### DETAILED DESCRIPTION OF THE INVENTION

Email Aggregation and Filtering: The Gayle Mail app collects emails from various accounts and provides a unified inbox. The app utilizes tags for items, subjects, and senders to filter emails and ensure only relevant messages are displayed to the user.

Manual Pre-filters: The app allows users to manually enter pre-filters, including selective emails, subjects, and key terms. Emails containing these specified words or phrases will be filtered and displayed in the Gayle Mail app.

Blocklist feature: Allows the user to not receive emails that meet the first criteria of pre-filters, but also contains selective emails, subjects, and key terms from the blocklist.

Artificial Intelligence Configuration: Gayle Mail also provides an option for automatic configuration of settings. By gaining access to the user's desktop and/or mobile device, including phone and email contacts, call logs, and voicemails, the app can analyze user behavior patterns.

User Profile Creation: Using artificial intelligence algorithms, Gayle Mail analyzes the user's frequently made or answered calls, rejected calls, and emails that are read or ignored. The app also examines trends in key words found in emails and voicemail messages that are read and listened to. Based on this analysis, Gayle Mail creates a personalized user profile that emphasizes the user's perceived importance.

Efficient Email Management: Gayle Mail ensures important emails are not overlooked, enabling users to prioritize their email accounts and avoid inbox clutter.

Personalized Filtering: The app allows users to manually set filters or leverage artificial intelligence to automatically configure settings based on their preferences and historical usage patterns.

Unified Inbox: Gayle Mail aggregates multiple email accounts into a single, easily accessible inbox, simplifying email management for users.

Quick and Convenient Setup: With the assistance of artificial intelligence, Gayle Mail rapidly creates a personalized user profile without requiring extensive manual configuration.

In conclusion, the Gayle Mail app offers a unique and innovative solution to effectively manage email inboxes by employing artificial intelligence for personalized email filtering. The app's ability to adapt to user preferences and historical usage patterns ensures important emails are promptly attended to, ultimately improving productivity, and reducing information overload.

1. A method for aggregating and filtering email inboxes, comprising:
a. receiving email data from multiple email accounts;
b. receiving voicemail data from mobile phone accounts
c. applying tags to items, subjects, and senders within the email data;
d. filtering the email data based on the tags to prioritize important emails;
e. providing a clutter-free inbox for the user.

2. The method of claim 1, further comprising:
a. allowing the user to manually add pre-filters by specifying selective emails, subjects, and key terms;
b. filtering emails based on the specified selective emails, subjects, and key terms.

3. The method of claim 1, further comprising:
a. utilizing artificial intelligence to automatically configure the filtering settings for the user;
b. accessing the user's desktop and/or mobile device to gather phone and email contacts, call logs, and voicemails.

4. The method of claim 3, further comprising:
a. analyzing the frequency of calls made, answered, and rejected;
b. analyzing the user's interaction with emails, including opened and unopened emails;
c. identifying trends in key words found within emails and voicemail messages read and listened to.

5. The method of claim 4, further comprising:
a. creating a user profile based on the analysis and identification of trends;
b. emphasizing important emails based on the user's history and preferences.

6. A system for aggregating and filtering email boxes, comprising:
a. a server configured to receive email data from multiple email accounts;
b. a tagging module to apply tags to items, subjects, and senders within the email data;
c. a filtering module to prioritize important emails based on the tags;
d. a user interface to provide a clutter-free inbox for the user.

7. The system of claim 6, further comprising:
a. an input module to allow the user to manually add pre-filters by specifying selective emails, subjects, and key terms;
b. a filtering module to filter emails based on the specified selective emails, subjects, and key terms.

8. The system of claim 6, further comprising:
a. an artificial intelligence module to automatically configure the filtering settings for the user;
b. an access module to gain access to the user's desktop and/or mobile device to gather phone and email contacts, call logs, and voicemails.

9. The system of claim 8, further comprising:
a. an analysis module to analyze the frequency of calls made, answered, and rejected;
b. an analysis module to analyze the user's interaction with emails, including opened and unopened emails;
c. a trend identification module to identify trends in key words found within emails and voicemail messages read and listened to.

10. The system of claim 9, further comprising:
a. a profile creation module to create a user profile based on the analysis and identification of trends;
b. a prioritization module to emphasize important emails and voicemails based on the user's history and preferences.

11. A computer-readable medium comprising instructions for executing the method of claim 1, wherein the instructions, when executed by a processor, cause the processor to perform the steps of:
a. receiving email data from multiple email accounts;
b. applying tags to items, subjects, and senders within the email data;
c. filtering the email data based on the tags to prioritize important emails;
d. providing a clutter-free inbox for the user.

12. The computer-readable medium of claim 11, further comprising instructions for executing the method of claim 2, wherein the instructions, when executed by a processor, cause the processor to perform the steps of:
a. allowing the user to manually add pre-filters by specifying selective emails, subjects, and key terms;
b. filtering emails based on the specified selective emails, subjects, and key terms.

13. The computer-readable medium of claim 11, further comprising instructions for executing the method of claim 3, wherein the instructions, when executed by a processor, cause the processor to perform the steps of:
a. utilizing artificial intelligence to automatically configure the filtering settings for the user;
b. accessing the user's desktop and/or mobile device to gather phone and email contacts, call logs, and voicemails.

14. The computer-readable medium of claim 13, further comprising instructions for executing the method of claim 4, wherein the instructions, when executed by a processor, cause the processor to perform the steps of:
a. analyzing the frequency of calls made, answered, and rejected;
b. analyzing the user's interaction with emails, including opened and unopened emails;
c. identifying trends in key words found within emails and voicemail messages read and listened to.

15. The computer-readable medium of claim 14, further comprising instructions for executing the method of claim 5, wherein the instructions, when executed by a processor, cause the processor to perform the steps of:
a. creating a user profile based on the analysis and identification of trends;
b. emphasizing important emails based on the user's history and preferences.

16. A method for configuring email filtering settings using artificial intelligence, comprising:
a. accessing a user's desktop and/or mobile device to gather phone and email contacts, call logs, and voicemails;
b. analyzing the frequency of calls made, answered, and rejected;
c. analyzing the user's interaction with emails, including opened and unopened emails;
d. identifying trends in key words found within emails and voicemail messages read and listened to;
e. utilizing artificial intelligence to automatically configure email filtering settings based on the analysis and identification of trends.

17. The method of claim 16, further comprising:
a. creating a user profile based on the analysis and identification of trends;
b. emphasizing important emails based on the user's history and preferences.

18. A system for configuring email filtering settings using artificial intelligence, comprising:
a. an access module to gain access to a user's desktop and/or mobile device to gather phone and email contacts, call logs, and voicemails;
b. an analysis module to analyze the frequency of calls made, answered, and rejected;
c. an analysis module to analyze the user's interaction with emails, including opened and unopened emails;
d. a trend identification module to identify trends in key words found within emails and voicemail messages read and listened to;
e. an artificial intelligence module to automatically configure email filtering settings based on the analysis and identification of trends.

19. The system of claim 18, further comprising:
a. a profile creation module to create a user profile based on the analysis and identification of trends;
b. a prioritization module to emphasize important emails based on the user's history and preferences.

20. The system of claim 18, further comprising:
a. a user interface to display and allow modification of the configured email filtering settings.
